(19) United States
(12) Patent Application Publication
(10) Pub. No.: US 2014/0001065 A1
(43) Pub. Date: Jan. 2, 2014

(54) MULTI-PRODUCT CONTAINER AND MANUFACTURING PROCEDURE

(71) Applicant: Maria Del Mar Martinez Navarro, Totana (Murcia) (ES)

(72) Inventor: Maria Del Mar Martinez Navarro, Totana (Murcia) (ES)

(73) Assignee: MIXPAKSYSTEM, S.L., Totana (Murcia) (ES)

(21) Appl. No.: 13/978,829

(22) PCT Filed: Jan. 10, 2012
(86) PCT No.: PCT/ES2012/070015

§ 371 Date: Sep. 18, 2013

(30) Foreign Application Priority Data
Jan. 10, 2011 (ES) P201130017

(51) Int. Cl. B65D 25/08; B31B 1/84; B31B 1/62; B31B 1/26; B31B 1/88

(52) U.S. Cl. CPC B65D 25/082; B31B 1/26; B31B 1/88; B31B 1/62; B31B 1/84
USPC 206/222; 493/53; 493/84; 493/95; 493/128

(57) ABSTRACT

Container for preparing a multiproduct, which comprises at least two products, one of said products being at least a first fluid and the other product possibly being a second fluid or a first solid product, said products being arranged in at least two compartments that are separated from one another by means of a seal that is frangible or can rupture under pressure, wherein a predetermined amount of the second fluid or first solid product is housed in one compartment and a predetermined amount of the first fluid is housed in the other compartment. By means of the present container, the products contained in the different compartments are prevented from mixing via the micropores in the material of the frangible seal, greater control is achieved over said seal and therefore problems when handling, storing and transporting the container are avoided, thereby increasing the storage life of the container, increasing the possibilities for using components that do not contain preservatives, enhancing the properties of the end product, and reducing unnecessary storage costs.

The present invention relates to a multiproduct container and its manufacturing procedure for the preparation of a product, ingredient, or component, formed from a fluid product in the liquid or gas state, or of a solid product, the solid product possibly being powdered or not, and a fluid, presenting at least two compartments keeping the products separate by a seal that is frangible or can rupture under pressure.

### BACKGROUND OF THE INVENTION

Containers intended for products with several components that must be kept separate during storage and that are only mixed when used are known in the state of the art; examples of these products are several medical products used in hospitals and adhesive products.

Some of these containers are constituted by two sheets of flexible metal, each sheet formed by an internal layer and an external layer, sealed through their internal layers to one another at their perimeter, such that they form a bag or envelope, in which interior two or more compartments are defined for the different products by making frangible sealing lines between the two sheets. The seals separating the compartments from each other can be broken, at the will of the user, to mix the components and use the resulting mixture. A container of the previous type applied to powdered egg is described in the European patent application EP1700789A1.

The containers of the state of the art can present ink impressions to include different information, such as identifying the trade name of the product, the characteristics of the products contained therein and their compositions, slogan, instructions of use, etc., among other possibilities. The impression of said information must be durable, that is to say, it cannot be affected by external conditions, but, on the other hand, it cannot affect the connection between the different layers of the sheets of the container negatively, due to which it must be made in the internal part of the container to the avoid the potential contamination of the stored product caused by the transfer of ink or varnish to the internal part of the container. This transfer of ink or varnish can be produced during the coiling process, given that the external part of the film making up the container is in contact with the internal part during the process, and if the inks or varnishes are in the exterior, the inks and varnishes can contaminate the internal part of the film making up the container, which in food or cosmetic products can affect the smell and/or taste thereof. The impression can also be external as long as the products are not susceptible of being contaminated or when stability tests have been carried out and the conservation of their state has been verified.

For example, containers presenting a barrier layer, such as, for example, a special polyester with an aluminum oxide sweep, which enhances the barrier characteristics of the polyester barrier, the subsequent impression and lamination process is complicated, just like the subsequent catalyzing process to which it is submitted, given that sudden temperature changes can affect the end result when produced during the catalyzing process, due to the fact that adhesions can be affected, which is an irreversible process. That is to say, once affected, it can never be rejoined. The aforementioned complications are due to the following factors:

the handling of the barrier layer must be delicate, given that the aluminum oxide particles can move if the layer is folded or handled in an inappropriate manner, even during the film complexing process by adhesion or co-extrusion, or during the recoiling and cutting process, which would cause said specific point not to have a barrier coating in the product,

printing on the barrier layer reduces the surface of contact between said layer and the peelable layer, usually made of peelable polyethylene, making the lamination by adhesion between both layers difficult, and

during the subsequent catalyzing process, it must remain at a controlled temperature during a specific period for the layers of the material to be correct and to avoid a subsequent delamination thereof. The adhesion not being perfect causes, when carrying out the subsequent sealing process and providing heat to the material, especially in the non-frangible seals where the material is peelable, the high temperature to cause a delamination between layers, which affects the behavior of the set as a whole, given that steam or moisture leakages could occur at the points where the sealing is carried out at a higher temperature. The delamination at the peelable or frangible area is least likely to occur, given that the temperature exerted on that area is not as high as in the other seals. Due to the foregoing, fully controlling the temperatures is very important, given that a delamination in the peelable seal is the most detrimental incident that could happen because it could cause the early mixture of the components prior to the exertion of the pressure for the rupture of the seal. Likewise, the material must be preserved at temperatures ranging between 10 and 30 degrees Celsius to maintain its characteristics unaltered, and introducing it into the conditioning room at least 24 hours prior to the packaging process so it adapts to the correct temperature and the packaging is guaranteed, is advisable.

The consequence of the metallic particles of the barrier layer moving with respect to their original situation is the uncovering of micropores existing in the polyester that could affect the contents of the container, especially the powdered product being stored, given that it causes an increase in the permeability of the material measured in cubic centimeters/m²×day, and could also cause an increase in the permeability parameters of steam measured in gr/m² day. If the product stored in the container is too hydroscopic, it will absorb the outdoor moisture or the moisture from the adjacent compartment housing a liquid product through the aforementioned micropores, which could damage the powdered product contained inside of the container. This is the case of powdered products with high sugar or sucrose content, among others. The foregoing can occur especially if the material loses its properties; said loss is caused by bad adhesion or by delamination during the sealing process, which is mainly caused by inappropriate storage or complexing, given that the manufacturing process of the products controls the sealing and its correct temperatures perfectly.

The aforementioned inconveniences have been solved by means of the object of the present invention, given that the incorporation of a layer of polymeric material, preferably polyester, to the barrier layers, acts as protection for the aforementioned parameters, which helps solving the existing problems to date in a significant manner.

### DESCRIPTION OF THE INVENTION

An objective of the present invention is to provide a container with at least two compartments, one with the first product or ingredient in the liquid or gas state, that is to say, a first fluid, and another with at least one second product or ingredient in the liquid or gas state, that is to say, a fluid, or a solid product or ingredient, either powdered or not, maintaining high levels of security and protection of the contents of the container, improving the preservation and transportation thereof, avoiding possible handling errors by the consumer, such as bumps inside the shopping cart, inappropriate storage, etc.

According to this objective, the present invention relates to a multiproduct container composed by at least a second fluid or solid product, being powdered or not, and a first product or first fluid, intended to contain said first and second products separated until their use, said container comprising at least two compartments separated by a seal that can rupture under pressure, wherein a predetermined amount of the second solid or fluid product is housed in one compartment and a predetermined amount of the first product or first fluid is housed in the other compartment, formed by a sheet of a flexible material with a laminate, characterized in that it comprises at least the following elements: a first internal layer of peelable polyethylene, with its internal surface in contact with the solid and liquid products, a second barrier layer of polyester with a coating, with its internal surface connected to the external surface of the first layer, and a third external layer of the container made of a polymeric material, preferably polyester (PET) at least 12 microns thick, with an impression between its internal surface and the external surface of the second layer to which said third layer is connected. Said impression is made preferably on the internal surface of the third layer, although making it in the external surface of the second layer is also possible. The connection between the different layers is preferably made by means of an adhesive, although making said connection by co-extrusion, thermoforming, or other equivalent means is also possible. Likewise, the connection between the different layers does not need to be made with the same means.

Other alternatives to the previous composition are the replacement of the barrier layer of polyester with an aluminum layer preferably of at least 7 microns. Said layer can also be replaced with a high-density polyethylene (PE/EVOH).

Likewise, the impression can be made in the external surface of the third layer rather than in the internal surface thereof, as long as the resistance of the impression materials to the adverse conditions they may be subjected to, such as friction and light, among others, is guaranteed. For this reason, the polyester (PET) must be submitted to a corona treatment that allows the impression on the external part rather than on the internal part, as described up to this point, given that without the corona treatment, the inks cannot be anchored to the material, causing a defective impression and the transfer and contact thereof with the internal part of the container during the recoiling process.

These characteristics allow storing and transporting the ingredients necessary to prepare the multiproduct from at least one solid fluid or product and a first fluid, in the liquid or gas state, at the same time and in a safe manner, thus avoiding having to measure or weigh the quantities of each ingredient. The mixed multiproduct, formed by the first and second products, is perfectly homogenized and without lumps.

Another appreciable advantage of the use of this invention is that it is very clean, given that the ingredients for the multiproduct can be mixed with one another in seconds inside of the container prior to being opened, in an aseptic manner and without auxiliary utensils or containers, ensuring its suitability for health processes and optimizing the preparation time of the mixture.

The present invention also ensures the preservation and non-contamination, even after the mixture is prepared, for a specific period of time, preferably refrigerated, which varies depending on the products contained in the container, given that there is no contact with the outside air at any time.

The packaging of the fluid, usually water, water together with the powdered product, also allows controlling the water, which is important because water is not the same everywhere. Depending on the characteristics of water to an important extent, the multiproduct does not always mix in the same manner, and the final characteristics of the multiproduct are not the same. In certain products, the amounts to be dosed must be exact; this is crucial for the good results of the end mixture and its subsequent use. By controlling the water, or fluid, the non-contamination of the end product is ensured.

Said bag is formed, as mentioned above, by at least one sheet of flexible material, which facilitates the rupture under pressure of the frangible seal by pressing the compartment of the fluid, in the liquid or gas state, such that the fluid presses the seal existing between the two compartments, causing its rupture. Preferably, said sheet is thermosealed along at least part of the perimeter of the bag. Said frangible seal, preferably with a uniform rupture pressure along the length thereof, derived from the complete control of the temperature and pressure during the manufacturing of said seal along the length thereof, allows the rupture thereof to be complete, without leaving unopened areas and thereby facilitating the mixture, given that a partial rupture of said seal would make the mixture process, and therefore, the end result of the product, difficult. The frangible seal therefore presents a higher or lower resistance to the rupture under pressure depending on the products contained therein and the size of the bag determined depending on the intended use, as well as on the target public of the container, given that the necessary pressure will be different if the final user is a child or an adult. The resistance to the pressure of the seal separating the different compartments is always obviously lower than resistance of the seals of the perimeter.

The barrier layer of polyester serves for the product to be in perfect conditions, avoiding contamination up to the moment of consumption. The barrier layer of polyester can also serve to replace the air of the interior of the container with a modified atmosphere to avoid the oxidation of the product and increase its life, thus likewise avoiding the entrance of oxygen and steam from the exterior to the interior of the envelope.

In one embodiment, at least one part of said sheet is transparent; this way, we can observe if the components have been effectively mixed prior to the opening of the container. Evidently, the sheet can be completely opaque.

Furthermore, the container can include other compartments in addition to the two aforementioned compartments to incorporate additional ingredients to the multiproduct, although said ingredients can also be contained in the same compartment than the first and second product. If the container comprises more than one compartment, the fluid must be in contact with at least one of the sides of the frangible seals to enable the rupture of the seals by transmitting the pressure exerted on the compartment of the fluid on one of the sides of the seals.

The compartment can present a scale represented on its external surface; the scale allows seeing the amount of multiproduct remaining in the container after making the mixture and using part of the contents.

The manufacturing procedure of the sheet making up the container object of the present invention comprises the following steps:

Impression with ink of the internal or external surface of the third layer or external layer of the container, preferably of treated polyester,

Lamination, preferably with a food adhesive, of the third layer with the second barrier layer of polyethylene with a coating, preferably of aluminum oxide in its internal surface, and

Lamination, preferably with a food adhesive or by co-extrusion, of the set of the previous layers with the first internal layer, in contact with the powdered and liquid products, of peelable or frangible polyethylene, which has been especially treated to preserve its sealing characteristics with respect to temperature, time, and exerted pressure, preferably of Surlyn polyethylene, making the layer of peelable or frangible polyethylene completely homogenous during the entire process to avoid possible needs for changes or fluctuations of temperature within the sealing process, mainly the frangible or peelable seal. The temperature, as well as pressure, time, and packaging control process during production, is part of the industrialization and is one of the basic and more important factors for the good use and operation of the product.

Then, the sheet is provided with the shape of the end container, determining the compartments and applying the thermosealing separating said compartments, as well as the perimeter seals, except on one of the sides, usually the upper sides, which is used for the introduction of the products or ingredients in order to proceed with the closing by sealing of said side after introducing the products or ingredients. It should be noted that the introduction of the products is carried out such that the oxygen content of the compartments after being closed is reduced, at approximately 3% and preferably between 2% and 3%, such that the oxidation of the products contained in the container is reduced. The pressure and/or temperature used for the perimeter seals are higher than the ones used for the frangible seal. Another important aspect is the control of the introduction of the components to be dosed into the envelope and the subsequent control of the upper seal, controlling the sealing processes to avoid a component from a compartment passing on to the other compartment prior to proceeding with the final closing of the envelope by means of the horizontal upper seal.

The seals can present different shapes, depending on the application of the container, such that a seal can be configured by determining an output channel generating a single output channel of the product after the opening, allowing its consumption in a simple and clean manner, either to be directly consumed from the container or to be dosed in another container.

The control of the temperature, pressure, and time carried out on the frangible or peelable seal, using the components of the materials determined in the present container, allows guaranteeing, at all times, the pressure that must be exerted to open the container or to mix the products contained therein, as well as ensuring the non-transmission of the components from a compartment to the other prior to the rupture of the frangible seal, and controlling that the rupture of said seal is complete along the length of its peelability.

Only the equipment capable of controlling and maintaining the temperature and pressure exerted on the sheet in a uniform manner are capable of transforming the material developed with guarantees. If the equipment is incapable of operating in this manner, envelopes with uneven distributions of temperature and pressure in their seals will be obtained.

The container object of the present invention can incorporate additional elements that facilitate the use of the contents thereof after the disappearance of the frangible seal and the mixture of the at least two components or products.

Likewise, this container allows controlling the resistance to the pressure of the seal located between the compartments containing the products to be mixed, such that, as mentioned above, it is possible to regulate the resistance to the pressure of said seal depending on the target public of the container, as well as the handling conditions thereof.

In addition to the advantages commented up to this point, the container object of the present invention enables:

The non-absorption by the frangible or peelable seal of the moisture from one compartment to the other, especially in the case of hydroscopic products,

Guaranteeing, in the case of containers wherein one of their compartments contains a fluid in the gas state, the internal non-displacement of the same through the micropores, and

Guaranteeing, in the case of containers where the two compartments contain a fluid in the liquid state, such as alcohol, acids, or liquid concentrates, the stability of both components, given that there is no transfer of one to the other, due to which the degradation due to the mixture of small particles does not take place.

### BRIEF DESCRIPTION OF THE DRAWINGS

For a better comprehension of what was exposed above, drawings have been attached, which represent a practical embodiment as an example and not in a limitative manner . . . .

In the drawings:

FIG. 1 is a schematic plant view representing a container according to the invention.

FIG. 2 is a sectioned view of the container of FIG. 1.

FIG. 3 is a sectioned view of the container with the frangible or rupturable seal, connecting both compartments, in the open position.

FIG. 4 is a sectioned view of the sheet formed by the three connected layers making up the container.

FIG. 5 is a plant view of an alternative container according to the invention.

### DESCRIPTION OF PREFERRED EMBODIMENTS

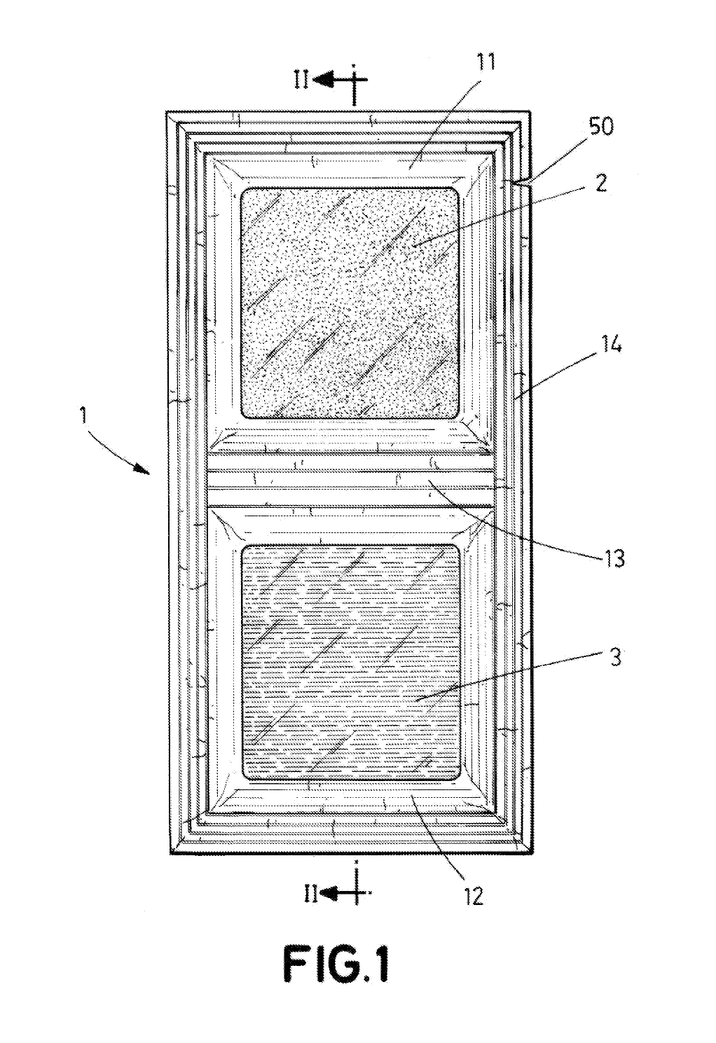

In the embodiment represented in FIG. 1, the container (1) for preparing a multiproduct consists of a determined amount of an ingredient, powdered ingredient or product (2), and a determined amount of a liquid (3), preferably water, appropriate to be mixed with the amount of powdered product (2) to obtain the liquid multiproduct with an appropriate proportion of the different components.

The container of the present example is a rectangular bag (1), which may be evidently manufactured in different shapes, divided into two compartments (11, 12) by means of a thermoseal (13), which is peelable, frangible or rupturable, that is to say, that may be opened by exerting pressure on the same from the compartment containing the liquid product (3).

As an alternative, FIG. 5 shows a container that comprises three compartments, separated from one another by frangible seals (13), wherein the liquid product (3) has been located in the lower compartment and two solid products (2), either the same or different, have been located in the central and upper compartments of the container. By exerting uniform pressure on the compartment with the liquid product, said pressure is transferred to the lower frangible seal (13), enabling its rupture and therefore the mixture of the liquid product (3) with the solid product (2). Subsequently, pressure would have to be once again exerted on the product obtained from the mixture to break the upper frangible seal (13) and mix the three components or products of the container. Evidently, the container may present more than two or three compartments.

The compartments (11, 12) are intended to contain, respectively, the amounts of a powdered product (2) and of a liquid, water (3), such that they remain separate up to the moment of the preparation of the multiproduct. As mentioned above, all the compartments may contain liquid or gas products, that is to say, fluids, and in the case of a solid product or products, they can be powdered or not.

As mentioned above, said powdered product can be any solid product, which may be edible or not, and which may be formed by different ingredients or sub-products which, in contact with a liquid, react in a certain manner. In particular, the possibilities of products to be housed in the different compartments are the following: solid/liquid or liquid/liquid. In any case, and as mentioned above, the liquid or solid may be replaced with a gas, and we can also include compartments other than the two aforementioned compartments to contain any of the foregoing.

The container (1) is manufactured with a sheet (15, 16), formed by at least one plastic material composed of several different layers, sealed to one another around the entire perimeter of the container (14), or by a sheet (15, 16), folded and sealed on three of its sides. Using two sheets sealed to one another at their entire perimeter is also possible.

It should be noted that these perimeter seals (14) of the container (1), which are also made by thermosealing and avoid the contamination of the product, have a much higher resistance than the resistance of the seal (13) separating the compartments, given that they should not be opened at the same time but must be kept sealed to isolate the contents of the container from the exterior.

As represented in FIG. 1, some of the parts (17) of the container (1) are transparent, to allow the visualization of the contents of each compartment (11, 12) and verify their states before opening it, as well as after making the mixture, although evidently it may be completely opaque.

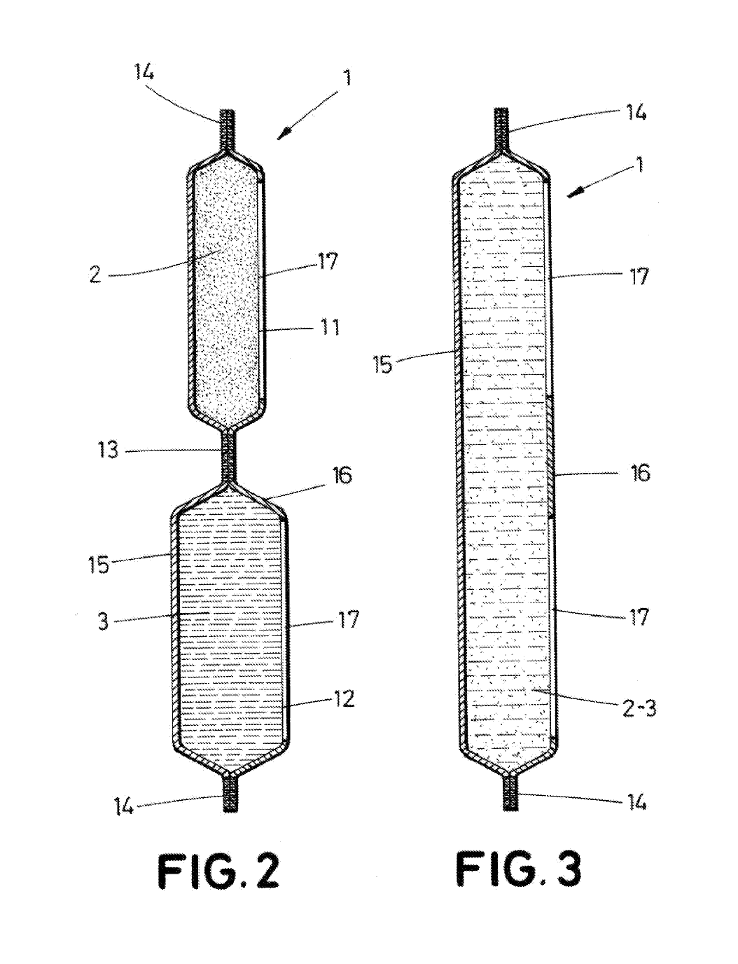

FIG. 2 shows a section of the container (1) of FIG. 1 with its compartments (11, 12) and its respective content of powdered product (2) and water (3). It should be noted that, in FIG. 2, the thickness of the different layers making up the sheet of the container has been merged and exaggerated to facilitate the comprehension of the drawing. On the right part of the figure, we can observe the transparent parts (17) that allow visualizing the contents of the two compartments (11, 12) before and after making the mixture.

If a user wants to prepare the mixture, he or she must simply press the compartment containing the liquid product or water with his or her hand, so the water contained in this compartment exerts force on the seal separating both compartments and opens it, such that the two compartments become one and the stored amounts of powdered product and water mix, as shown in FIG. 3, while the container remains sealed from the exterior.

After shaking the container lightly to homogenize the contents, in a completely clean manner and without the need to use another container or tool, the same can be opened and the multiproduct can be poured into the appropriate container or elements allowing the direct consumption from the container, such as a cup or valve. Optionally, the container can incorporate any means to facilitate its opening, to pour the product, to close the container if its contents are not used in their entirety, etc.

As mentioned above, the present container allows mixing the powder-fluid or the fluid-fluid in a simple manner, by pressing the part of the envelope containing the fluid component or product, which in turn allows an easy and energetic shaking after the rupture of the frangible or peelable seal until its complete dilution. After being diluted, it allows the opening of the container at the previously determined extremity. Said opening can be preferably carried out by means of a tear notch (50) for its consumption, which may be drunk or cooked. Said tear notch is located in the container such that it allows the easy opening at the fully sealed area. Said tear notch (50) is to be especially applied to containers containing polyester and aluminum, given that, without this tear area, the opening would not be possible without additional accessories, such as scissors.

In addition, a scale to allow assessing the amount of multiproduct remaining in the same after using part thereof can be represented in the external surface of the container.

In addition, in the same compartment or in another separate compartment, other ingredients for the multiproduct to be prepared can be included.

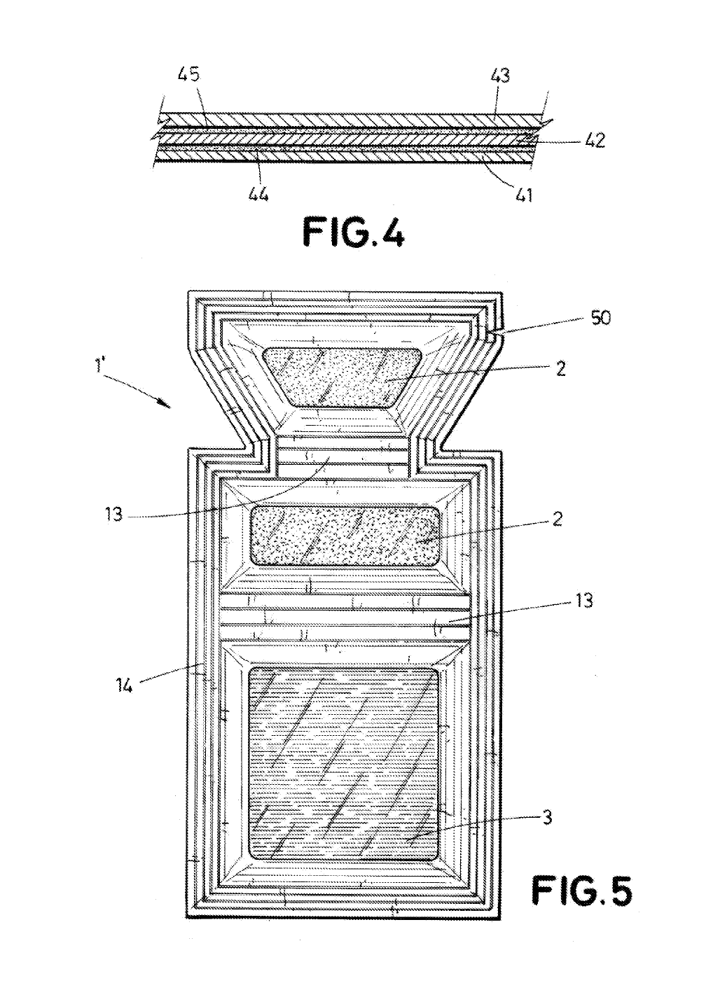

FIG. 4 shows a section of the sheet (15, 16) making up the container of FIG. 1, wherein the three layers making up the same can be observed.

The thickness of the different layers (41, 42, 43) making up the sheet (15, 16) shall depend on the external conditions to which the container is to be subject, such as, for example, handling and transportation conditions, to resist them same without deteriorating, and therefore, without the contents of the container being affected, as well as the ingredients included in the container.

In terms of the container (1), an appropriate material to make the sheet (15, 16) making it up is a laminate made of a transparent plastic material, composed of a first internal layer (41) of peelable and sealable polyethylene (PE), preferably Surlyn polyethylene, with a weight of 65 g/m², in contact with the ingredients at its internal surface; a second intermediate layer (42) of polyester (PET) with a thickness between 2 and 20 μm, preferably 12 μm, with barrier properties, preferably polyester with an aluminum oxide sweep (44), in contact with the external surface of the first layer (41) in its internal surface to protect the interior of the container from moisture; and a third external layer (43) made of polyester (PET) with a thickness between 2 and 20 μm, preferably 12 μm, with an impression (45) in ink in its internal surface adhered to the external surface of the second layer (42).

The different layers are connected to one another by means of adhesives that allow an adhesion of at least 3N/15 mm, preferably 3.5 N/15 mm, and with a weight of at least 2.5 gr/m², preferably 3 gr/m², each, such that mass of the ink, of about 105 gr/m², must be added to the total weight of the container of the example.

The transverse elongation of the sheet making up the container is of at least 50%, preferably 70%, and the longitudinal elongation is of at least 80%, preferably 100%. With these characteristics, we avoid problems in its handling, storage, and transportation. Likewise, the resistance of the seal is at least 4N/15 mm, 5 N/15 mm being preferred.

1. Multiproduct container that comprises at least a first product and a second product, the at least first product being a fluid, intended to contain said products separate until its use, said container comprising at least two compartments separated from one another by means of a seal that is frangible or can rupture under pressure, wherein a predetermined amount of the first product or first fluid is housed in one compartment and a predetermined amount of the second product is housed in the other compartment, formed by a sheet of flexible material with a laminate, characterized in that it comprises at least the following elements:
a first internal layer of peelable polyethylene, with its internal surface in contact with the solid and liquid products,
a second barrier layer of polyester with a coating in its internal surface and with its internal surface connected to the external surface of the first layer,
and a third external layer of the container made of a polymeric material, with its internal surface connected to the external surface of the second layer.

2. Container, according to claim 1, characterized in that the second product is a solid product.

3. Container, according to claim 2, characterized in that the solid product is powdered.

4. Container, according to claim 1, characterized in that the second product is a fluid.

5. Container, according to claim 1, characterized in that it comprises three separate compartments.

6. Container, according to claim 1, characterized in that the third layer is made of polyester.

7. Container, according to claim 1, characterized in that the second barrier layer of polyester is replaced by an aluminum layer.

8. Container, according to claim 1, characterized in that said sheet is thermosealed or co-extruded along the length of at least one part of the perimeter of the container (1).

9. Container, according to claim 1, characterized in that at least one part of said sheet is transparent.

10. Container, according to claim 1, characterized in that the barrier polyester presents a metal or ceramic coating.

11. Container, according to claim 10, characterized in that the metal coating is made of particles of aluminum oxide.

12. Container, according to claim 1, characterized in that it comprises an impression between the internal surface of the third external layer and the external surface of the second layer with which it is in contact.

13. Container, according to claim 1, characterized in that it comprises an impression made on the external surface of the third layer.

14. Container, according to claim 1, characterized in that the different layers are connected to one another by means of an adhesive.

15. Container, according to claim 1, characterized in that the pressure of rupture along the frangible seal is uniform.

16. Container, according to claim 1, characterized in that the oxygen content of the compartments is approximately 3%.

17. Manufacturing procedure of a multiproduct container with at least two compartments to store at least two products, which are separate from one another by means of a seal that is frangible or can rupture under pressure, characterized in that it comprises the following steps for the manufacturing of a sheet:
Lamination of a third layer of treated polyester with a second barrier layer, and
Lamination, of the set of the previous layers with a first internal layer of peelable polyethylene which is in contact with the products to be stored in the container.

18. Procedure, according to claim 17, characterized in that an impression with ink is made on the internal or external surface of the third layer or on the external layer of the container.

19. Procedure, according to claim 17, characterized in that the barrier layer is polyester with a metal or ceramic coating.

20. Procedure, according to claim 17, characterized in that the barrier layer is made of aluminum.

21. Procedure, according to claim 17, characterized in that the lamination is carried out by means of a food adhesive or by co-extrusion.

22. Procedure, according to claim 17, characterized in that, after giving the desired shape to the sheet, two sheets connected to each other are connected to the first sheet by means of the application of different controlled perimeter sealings in the entire perimeter of the sheet during a specific time and at a specific pressure and temperature, except on one upper side thereof, making up a container open at said side.

23. Procedure, according to claim 22, characterized in that, after the perimeter sealing, at least one controlled frangible seal is applied, determining at least two independent compartments in the container, the time, pressure, and temperature of said frangible seal being lower than those applied to the perimeter seals.

24. Procedure, according to claim 23, characterized in that the filling of the compartments, free of oxygen and with at least one fluid through the upper side, is then carried out.

25. Procedure, according to claim 24, characterized in that a perimeter seal is applied to the upper side.
